(19) United States
(12) Patent Application Publication
(10) Pub. No.: US 2007/0285502 A1
(43) Pub. Date: Dec. 13, 2007

(54) Techniques for automatically setting up communications

(75) Inventor: Dawson Yee, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/441,704

(22) Filed: May 26, 2006

(51) Int. Cl. H04N 7/14

(52) U.S. Cl. 348/14.08

(57) ABSTRACT

Techniques are provided for automatically setting up a communication event. A request for a communication event is registered with an automated agent. The automated agent determines an availability status of each participant in the communication event. The communication event is established.

### BACKGROUND

There are varying modes of communication that one person may use to communicate and connect with one or more other parties. Modes of communication may include, for example, voice conferencing via telephone, text messaging, and video conferencing. As part of arranging a communication event between two or more parties, such as to schedule a telephone conference call, different techniques may be used to determine the availability of all parties. Depending on when the communication event is to occur, one may need to make a determination regarding current availability, such as for real time communications, or future availability, such as to schedule a conference call at a future time.

One existing technique that may be used to determine both a current availability and a future availability is the use of a calendar and scheduling application program. A first user may schedule his/her appointments using the program and may also make his/her appointment schedule available to other users so that the other users can determine the availability of the first user. It can be time consuming to manually examine each participant's calendar to determine availability.

Another technique involves manually setting an indicator with an application on a user's computer. The indicator can be viewed by others to determine a current availability for the user. As with the calendar and scheduling program, one drawback is that the indicator may not accurately reflect the user's availability, for example, if the user has not appropriately updated the indicator to reflect any changes in status. The status of the indicator may be updated automatically to indicate that the user is not present or available in accordance with detected inactivity of a user computer, such as, for example, when the screensaver is displayed on the user's computer due to inactivity. Even this automated updating has a drawback in that the user may actually be available, but not operating his/her computer, which may be the reason for the computer inactivity detected.

Even if one or more of the foregoing accurately reflect the availability of all participants in a communication event, steps to determine availability and any needed confirmation of a future communication event may be performed manually which can be a time consuming process.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are provided for automatically setting up a communication event. A request for a communication event is registered with an automated agent. The automated agent determines an availability status of each participant in the communication event. The communication event is established.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a user computer for use in connection with performing the techniques described herein;

FIG. 3 is an example of components that may be included in an embodiment of a server computer for use in connection with performing the techniques described herein;

FIG. 4 is an example illustrating data flow between some of the components of FIGS. 2 and 3 in connection with the techniques described herein;

FIGS. 5 and 6 are flowcharts of processing steps that may be performed in an embodiment in connection with the techniques described herein; and

FIG. 7 is another flowchart of processing steps that may be performed in an embodiment in connection with the techniques described herein.

### DETAILED DESCRIPTION

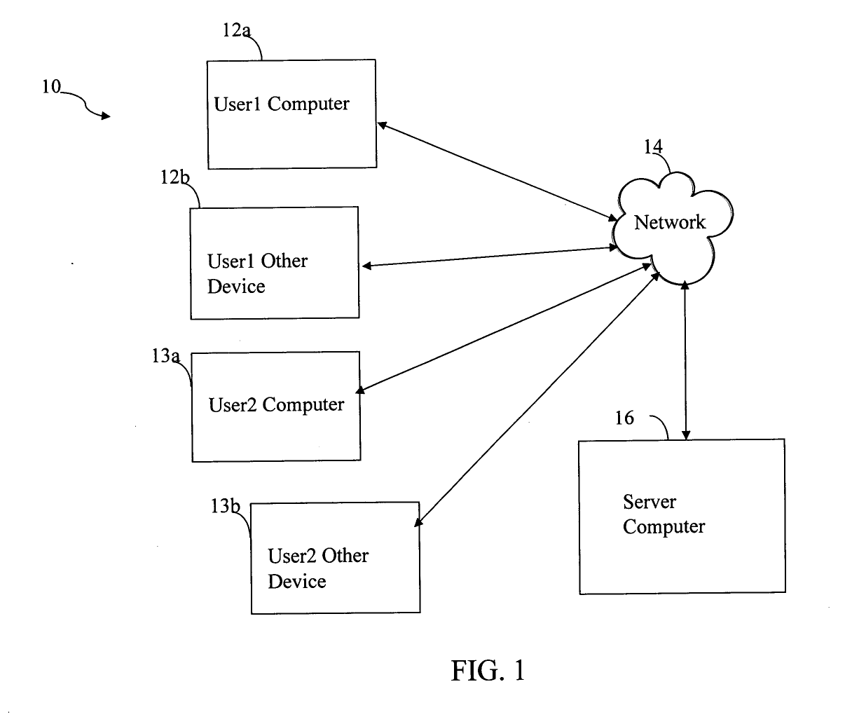

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein for facilitating automated arrangement and set up of a communications event. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are a computer 12a for user 1, another device 12b for user 1, a computer 13a for user 2, another device 13b for user 2, a network 14, and a server computer 16. The devices 12b and 13b may be, for example, an office phone or a wireless device, such as a mobile phone or a PDA. The computers 12a and 13a and other devices 12b and 13b included in FIG. 1 are exemplary for purposes of illustrating the techniques described herein in connection with automatically setting up communication events between participants, such as user 1 and user 2. Any device, including a computer or other wireless or non-wireless device, that has connectivity to the server 16 and having the functionality described herein may be included in an embodiment. Additionally, although a particular number of devices are illustrated, an embodiment may use one or more devices. The computers 12a and 13a and devices 12b and 13b may include a processor used to execute code included in one or more program modules. Described in more detail elsewhere herein are program modules that may be executed by the devices in connection with the techniques described herein. The computers 12a and 13a and devices 12b and 13b may operate in a networked environment and communicate with the server computer 16 and other computers not shown in FIG. 1.

In operation, one of the users in the example 10 may desire to arrange a communication event, such as a telephone conference, video conference, instant message, and the like, with one or more other users as participants in the event. Techniques are described herein in connection with automating the process of establishing or setting up the communication event between all participants. This may include, for example, receiving a request for a communication event, determining an availability of each participant for the event, contacting each participant at the time of the event, and connecting or linking communications between the participants for the event.

It will be appreciated by those skilled in the art that although the computers 12a and 13a and devices 12b and 13b are shown in the example as communicating in a networked environment, the computers and other devices may communicate with other components utilizing different communication mediums. For example, the user computer 12a may communicate with one or more components utilizing a network connection, and/or other type of link known in the art including, but not limited to, the Internet, an intranet, or other wireless and/or hardwired connection(s).

In following paragraphs, an automated agent on the server computer 16 may be used to facilitate establishing one or more requested communication events in an automated fashion. The automated agent may communicate with other components to perform steps that may vary in accordance with each communication event and an associated requested. In one embodiment as described herein, physical presence of communication event participants relative to one or more communication devices and available communication modes for the devices may be used in connection with determining availability of the participants for the event. Physical presence detection is described herein and in TECHNIQUES FOR PHYSICAL PRESENCE DETECTION FOR A COMMUNICATIONS DEVICE, Yee et al., filed on May 18, 2006, Attorney Docket No. MS Ref. 315806.01/MFS-018US, which is incorporated by reference herein, and referred to herein as the “physical presence detection application”.

Additional detail regarding illustrative embodiments of components from the example 10 of FIG. 1 will now be described.

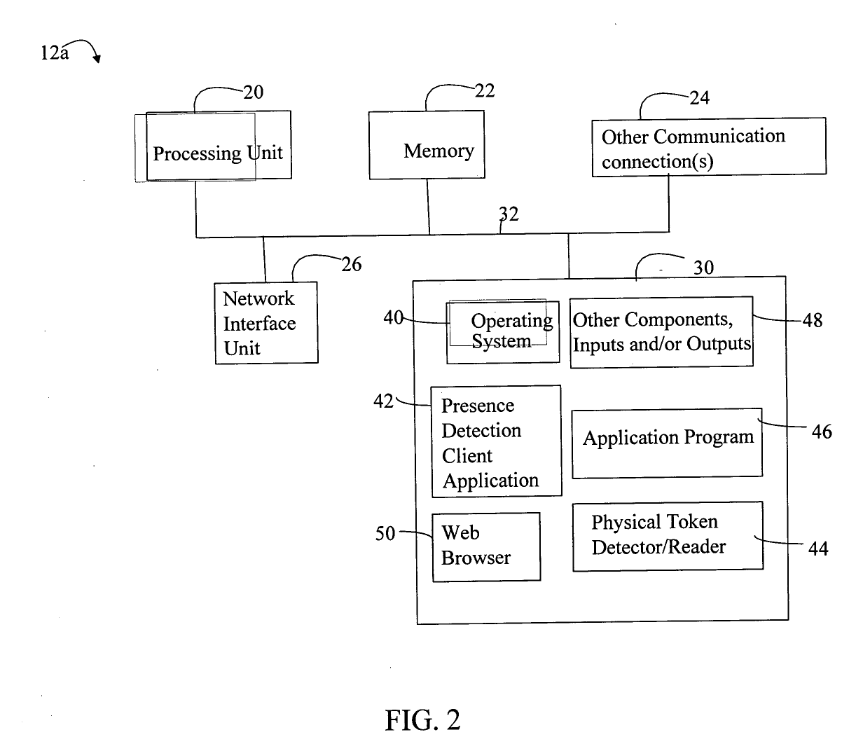

Referring now to FIG. 2, shown is an example of components that may be included in one of the user computers 12a as may be used in connection with performing the various embodiments of the techniques described herein. The user computer 12a may include one or more processing units 20, memory 22, a network interface unit 26, storage 30, one or more other communication connections 24, and a system bus 32 used to facilitate communications between the components of the computer 12a.

Depending on the configuration and type of user computer 12a, memory 22 may be volatile (such as RAM), non-volatile (such as ROM, flash memory, etc.) or some combination of the two. Additionally, the user computer 12a may also have additional features/functionality. For example, the user computer 12a may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the user computer 12a. The storage 30 in one embodiment may be a mass-storage device with associated computer-readable media providing non-volatile storage for the user computer 12a. Although the description of computer-readable media as illustrated in this example may refer to a mass storage device, such as a hard disk or CD-ROM drive, it will be appreciated by those skilled in the art that the computer-readable media can be any available media that can be accessed by the user computer 12a.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by user computer 12a. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The user computer 12a may also contain communications connection(s) 24 that allow the user computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the user computer 12a may operate in a networked environment as illustrated in FIG. 1 using logical connections to remote computers through a network. The user computer 12a may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the user computer 12a, one or more of these elements included in the storage 30 may also reside in a portion of memory 22, such as, for example, RAM for controlling the operation of the user computer 12a. The example of FIG. 2 illustrates various components including an operating system 40, a presence detection client application 42, a physical token detector/reader 44, one or more application programs 46, web browser 50, and other components, inputs, and/or outputs 48.

The operating system 40 may be any one of a variety of commercially available or proprietary operating systems. The operating system 40, for example, may be loaded into memory in connection with controlling operation of the user computer. One or more application programs 46 may execute in the user computer 12a in connection with performing user tasks and operations.

The presence detection client application 42, physical token detector/reader 44 and one or more application programs 46 may be used in connection with physical presence determination of a user with respect to a device.

The presence detection client application 42 may be characterized as a client application which is used in connection with setting and/or detecting the physical presence of a user with respect to a device. The client application 42 communicates presence-related information to the server computer. Such presence-related information may include, for example, a determination regarding the detected physical presence of a user, and other information. In one embodiment, the physical presence setting may be determined in accordance with one or more components of presence-related information. A first component used in determining a physical presence setting may be generated by the physical token detector/reader module 44. Additionally, an embodiment may determine a physical presence setting using a manually specified physical presence setting and/or one or more other secondary indicators. As described herein, the secondary indicators may include static and/or dynamic information. Both the first component and any other presence-related information produced on the user computer or other device may be communicated to the client application 42 as described herein. The client application 42 may then communicate such information to the server 16.

It should be noted that any one of a variety of different techniques may be used to communicate the presence-related information to the server computer. For example, the information, and any updates or changes thereto, may be pushed from the user computer 12a to the server computer. It will be appreciated by those skilled in the art that other techniques, such as pulling information from the user computer, polling, and the like, may also be used.

The physical token detector/reader module 44 may be used in connection with generating the foregoing first component of presence-related information. The detector/reader module 44 may be used to detect the physical proximity or presence of a physical token that is carried by a user. The physical token may be any one of a variety of different tokens known in the art. For example, a physical token may be a tag such as an RFID or infrared tag that is carried by a user. Encoded on the tag may be information identifying the user. When the user with the tag is in close proximity to the detector/reader module 44, the module 44 reads the information on the tag and communicates the information to the presence detection application 42 where the first component of the user's physical presence setting as communicated from the detector/reader module 44 is determined to be “present”. When the user and the physical token move away or out of range of the module 44, the first component of the user's physical presence setting as generated by the detector/reader module 44 is determined to be “away” or not presently near the device containing the detector/reader module 44. Thus, the physical presence or proximity of the user with respect to the device, which in this example is the user computer 12, is determined by communicating with the physical token. Other types of physical tokens may include those containing magnetically encoded data.

It should be noted that the detector/reader module 44 may vary in accordance with the types of physical tokens used in an embodiment. The physical tokens that may be used in an embodiment in connection with the techniques described herein are also not limited to those which may be characterized as wireless or otherwise operating without having the token come into direct physical contact with the detector/reader module 44. An embodiment may also use physical tokens which operate by coming into direct physical contact with the detector/reader module 44. For example, in another embodiment, the user may have a physical token which is a card, such as Smart Card. The card may be, for example, a pocket-sized card with embedded information thereon including information identifying the user. The card may be physically inserted into a Smart Card or other card reader to obtain the information identifying the user.

The application program 46 may be, for example, code which monitors the activity on the computer 12 causing display of a screensaver when there is inactivity. One or more such application programs may be used in generating one or more secondary indicators communicated to the presence detection client application 42. Secondary indicator information may then be communicated to the server computer. For example, when the screensaver is displayed, an application program may provide a secondary indicator to the client application 42 indicating that the user is “away” from the device, which in this example is a computer.

In one embodiment, the device 12 may include an application program 46 that is a client-side calendar and scheduling program reporting scheduling information to a central location, such as to a server-side calendar and scheduling application on server 16. The client and server-side calendar and scheduling applications may be utilized to schedule meetings, keep a calendar of activities, appointments, and the like. A secondary indicator used in connection with physical presence detection may be generated in accordance with querying the server-side calendar and scheduling application for one or more data items. The data items may include information about whether the user's calendar indicates a scheduled meeting or appointment (e.g., is time blocked out as busy or taken). For each scheduled meeting, the corresponding appointment entry may be parsed to search for keywords in a subject line or other fields. From the existence of particular keywords in the entry, additional availability inferences may be concluded. Such inferences may be included in the secondary indicator information from the server-side calendar and scheduling application. For example, the appointment entry may indicate “out of office” or at an offsite meeting (e.g. physically away from devices in the office), an onsite meeting (e.g. physically in the office but having limited availability to take certain types of communications such as text messages), “office hours” (e.g., physically present and near devices in the office and available to take all communications), and the like.

As an alternative to, or in addition to, the foregoing in which an inference is drawn from the context of an entry, an embodiment of the client-side and server-side calendar and scheduling applications may include functionality for explicitly setting an appointment indicator, such as from a menu selection, which is the associated with an appointment entry. As with the use of the keywords, the appointment indicator may provide additional information regarding the appointment. Such information may be included in the secondary indicator information from the server-side calendar and scheduling application. Using such additional information may allow a finer granularity of filtering of communications to a user at one or more devices. For example, an embodiment may assume that whenever a calendar indicates a scheduled appointment, the user is busy and unable to take any communications. If additional information regarding the scheduled appointment is provided, such as with the appointment indicator or detected keywords, a finer granularity of filtering of communications to the device may be performed. For example, a scheduled appointment may be for a meeting as determined using the keywords or explicitly set appointment indicator from the entry associated with the scheduled meeting. As such, the user may be able to accept text messages transmitted to the user's a registered mobile device. Secondary indicator information such as the foregoing may be used in filtering communications to the user on his/her mobile device during the times of the scheduled meeting. The secondary indicator information may indicate the type or mode of communications allowed (e.g., text) and the date/time of the meeting. The secondary indicator generated by the server-side calendar and scheduling program may provide an indication that the user is “present” or “away” with respect to a device and/or location, such as an office. Additionally, the secondary indicator may provide other information used to determine if one or more modes of communication may be transmitted to a particular device. For example, if the calendar indicates a user is in a meeting, the secondary indicator may indicate that, for the duration of the meeting, only text communications may be transmitted to a device.

It should be noted that a secondary indicator may be used in connection with the device on which a client-side application program executes and possibly other devices which may not have a corresponding client-side portion executing thereon. For example, if the client-side calendar and scheduling application as described herein is on a personal computer in the office, secondary indicators generated using the calendar entry for a meeting (e.g., as obtained from the server-side portion of the application) may affect transmissions to the personal computer as well as a phone or other devices known to be in the same physical location as the personal computer. The other devices may not have a client-side calendar and scheduling application executing thereon. If the user is at an offsite meeting, communications directed to a device in the office location, such as an office phone, may be affected by information obtained from the server-side application, such as by having any voice transmissions for the office phone forwarded directly to voicemail. Whether an embodiment uses collected information to make such inferences applicable to more than one device may vary with embodiment.

Secondary indicators may also be inferred from dynamic physical attribute information regarding the current physical state of the device. Such information may be used in filtering certain communications to associated devices. The types or modes of communication to forward or otherwise filter to a device may be inferred from a physical state of the device. For example, if a cover is over a display of a mobile device (e.g., in a closed position), it may be inferred that the user does not want to view text messages or examine information that may be displayed regarding an incoming call. In this instance where the mobile device is capable of receiving text and voice transmissions, both modes may be disabled in response to the closed positioning of the cover. Similarly, if a cover over a keyboard of a device is in a closed position, it may be inferred that the user does not want to receive text messages. In another example, if a mobile phone is retracted/folded with the display showing, it may be inferred that voice transmissions but not text transmissions should go to the mobile phone. A user may set the mobile phone to the foregoing, for example, while driving and using a hands-free phone attachment. The user is able to have a telephone conversation but is not able to process text messages. In yet another example, if the mobile phone is retracted/folded and a cover is placed over the display so that displayed data cannot be viewed, it may be inferred that all voice communications to the device should go directly to voicemail. In connection with the foregoing, code executing on the device may monitor the current physical state of the device and communicate such information as secondary indicator information to the client application 42 which may then be communicated to the server computer.

As described above, the presence detection client application 42 receives information from the physical token detector/reader module 44 used in connection with generating the foregoing first component of presence-related information. An embodiment may provide the first component, one or more secondary indicators and/or a manual physical presence setting to the client application 42. As described herein, the manual setting and/or secondary indicators may be used in combination with the first component to generate a final setting regarding the physical presence of a user with respect to a device. Depending on the particular secondary indicator information, the secondary indicator information may also be used in connection with forwarding communications to user devices. The client application 42 may communicate all received information including the first component, manual setting, and any secondary indicator information to the server computer. As described herein, a secondary indicator may include additional information used in making a final determination regarding physical presence. A secondary indicator may also include other information used in determining what modes of communications are routed or forwarded to a device.

It should be noted that in one embodiment described herein, a final physical presence setting may be determined as a composite of the first component, manual presence setting, and/or secondary indicator information. In one embodiment described herein, the determination regarding the final physical presence setting is performed by the presence aggregation engine of the server computer.

Although details of one particular device, the user computer 12a, have just been described, it will be appreciated by those skilled in the art that other devices, including user computer 13a and other devices 12b and 13b, may include components similar to those described in connection with the user computer 12a to perform the presence detection techniques described herein.

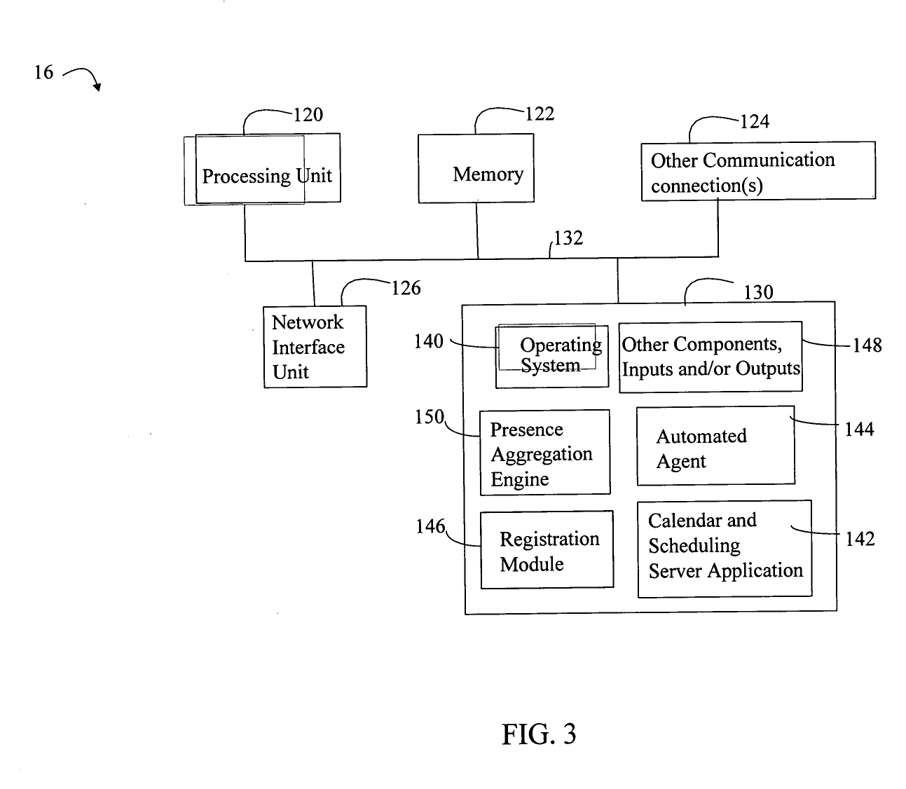

Referring now to FIG. 3, shown is an example of components that may be included in the server computer and used in connection with performing the various embodiments of the techniques described herein. As illustrated in FIG. 3, an embodiment of the server computer 16 may include components similar to those described in connection with FIG. 2. Additionally, the server computer 16 may include a presence aggregation engine 150, a calendar and scheduling server application 142, an automated agent module 144, and a registration module 146.

It should be noted that although the presence aggregation engine 150, automated agent 144 and calendar and scheduling application 142 are illustrated in this example as being on the same server, each of the foregoing may reside on one or more different server systems in connection with performing the techniques described herein.

The registration module 146 may be used in connection with registration of a user and one or more devices associated with the user. The presence aggregation engine 150 and the automated agent 144 may perform other processing as described herein for such registered users. As part of the registration process, the user may be assigned a user identifier and register one or more associated devices for the particular user identifier. The user may also be assigned a password or other information used in connection with device authentication. The user identifier may be included on the physical token identifying the user as described elsewhere herein. As an example of device registration, a user may register multiple devices as illustrated in FIG. 1 which are associated with the user's identifier. Each device, such as a phone, computer, mobile phone, or PDA, may have its own IP address or associated location so that the device may be identified in the network in connection with communications, such as for forwarding an incoming transmission received at the server computer 16. Each registered device may have an associated one or more modes of communication. Modes of communication may include, for example, voice, text, and/or video, indicating which types of communication a particular device is capable of. For example, a mobile device may be capable of voice, text and video. An older device may only be capable of voice and text. A particular computer system that is registered may be capable of only voice and text. The modes of communication which a device is capable of may vary in accordance with the particular device and associated configuration.

The calendar and scheduling server application 142 is a server-side application which, as described elsewhere herein, collects and maintains calendar and appointment information for one or more users. Schedule and appointment information may be communicated from a corresponding client-side portion of the application residing on one or more user devices.

The presence aggregation engine 150 aggregates physical presence settings and other presence-related information of one or more devices for a registered user. The other presence-related information may include the manual physical presence setting for a device and secondary indicator information described herein. The engine 150 may query the server application 142 to obtain a portion of the secondary indicator information regarding schedules and appointments.

The secondary indicator information may include static and/or dynamic information. Secondary indicator information that is static may include, for example, registration information such as what devices are associated with a user identifier and the modes of communication capable by each device. This information may be characterized as static in that it may not be modified in accordance with changing or dynamic aspects of the system. Secondary indicator information that is dynamic may be, for example, information communicated to the engine 150 from the device and used in connection with filtering different modes of communications to a device as described elsewhere herein.

Information as maintained by the engine 150 may be made available to registered users, and also other components such as the automated agent 144 described in following paragraphs, so that a registered user or the agent 144 may be aware of the final physical presence setting for one or more registered users as determined using the techniques described herein with respect to a device. The engine 150 may also make available the different modes of communication and current status of each user's registered devices. Using such information, the agent 144 may determine the best way to contact or reach another user.

Each device has its own physical presence setting as determined using the techniques described herein. When one of the devices boots up, such as a phone or computer system, device authentication may be performed. In one embodiment, the user is prompted for a username and password to be used for authentication with the server computer. In an embodiment, a user may be allowed to selectively enable/disable presence detection for one or more registered devices. Presence detection may refer to determining physical presence as well as availability of a user for device with respect to one or more modes of communication. As a default, presence detection may be performed for all registered devices associated with a user identifier. The selective enabling/disabling of presence detection for registered devices may be performed in connection with registration on the server computer and may be updated at a later point in time. For example, when a device boots up, a user may be allowed to specify whether to enable or disable presence detection for the device. The enabling/disabling of presence detection for a device may also be characterized as dynamic information that may be modified at boot up and/or subsequent to boot up, and then communicated to the client application 42 as secondary indicator information. Such information may be further communicated to the presence aggregation engine 150 at the server computer.

An embodiment may also allow a user to selectively enable/disable different communication modes for a registered device. For example, a device may be capable of receiving voice, text, and video and may be accordingly registered on the server computer for a particular user. Even though the device is capable of all three modes of communication, a user may selectively choose to enable/disable one or more of these three modes. The selective enabling/disabling of certain modes of communication may be specified as part of registration, device boot up, and/or further modified after boot up. The enabling/disabling of certain modes of communication as part of device boot up and/or subsequent to boot up may be characterized as dynamic information communicated to the client application 42 as secondary indicator information. Such information may further be communicated to the presence aggregation engine 150 at the server computer.

The automated agent 144 performs processing for automatically setting up or establishing a communication event in accordance with a request. In one embodiment, a user may submit one or more such requests for establishing a communication event. Such requests may be submitted to the automated agent 144, for example, using a web browser such as on the user computer 12a.

A request may include one or more portions of request information. For example, in one embodiment, a request may include at least the following minimum information: the one or more participants for the communication event, the type of communication event or mode of communication (e.g., telephone conference, video conference, other future time/scheduled or real-time communication), and a time specifier for the requested communication event (e.g., a time of day, a date, first/earliest available date/time). A request may also include the following: a length of time of the event, an indication as to whether an alternate time may be used if a particular requested time is not available, a list of one or more alternate times, and a dependency indicator with respect to one or more other requested communication events to be processed by the automated agent. The dependency indicator may specify if the event associated with the current request has an order dependency with respect to one or more other requests. For example, a first request may be for a first telephone conference between A and B at any time during a business day. A second request may be for a second telephone conference which may take place at any time during a business day. However, it may be that the second request is not to be processed until the communication event for the first request has occurred. As such, the second request may specify the foregoing dependency on the first request. It should be noted that an embodiment may include restrictions on requests specifying a dependency upon another request. Referring to the previous example, the first and second requests may be included in the same submission/set of requests. Additionally, the first request which is referenced in the second request may be specified prior to the second request in the submission. The inclusion or omission of any such restrictions may vary with embodiment.

The request may also include an indication as to whether the communication event may proceed at the requested time with less than all requested participants. In one embodiment, the request for a communication event may specify that one or more participants are required and the communication event is allowed to proceed if at least the required parties are available.

An embodiment may process requests as described herein and also using different additional information. Furthermore, an embodiment may also specify a minimum set of request information than as specified herein.

The automated agent 144 may communicate with the presence aggregation engine 150 and/or the calendar and scheduling server application 142 in connection with establishing or setting up a requested communication event. The automated agent 144 may utilize information in the server application 142 to obtain scheduled appointment information for event participants. For example, the agent 144 may examine the calendar information for all requested participants to determine availability at a current time, or at a future time. The agent 144 may also reserve time in a participant's calendar for a requested event.

The automated agent 144 may communicate with the presence aggregation engine 150 to obtain information regarding the physical presence of each participant and the available modes of communication of each participant. The available modes may be based on the capabilities of each device as well as whether a user has enabled/disabled different communication modes for a device. Additionally, the currently available communication modes may also be in accordance with a physical device attribute and other information as may be used by the engine 150 to determine available communication modes for a user's registered device as well as an associated physical presence indicator for the device.

The agent 144 may query the engine 150 to obtain the physical presence indicator with respect to a device at a current point in time for a user. Additionally, the agent 144 may query the engine 150 to obtain information regarding the available modes of communication associated with a user's registered devices. Using the physical presence information of the parties with respect to one or more devices and the available mode(s) of communication associated with each such device, the automated agent may determine user availability and can establish the communication event by setting up the communication links between all parties when present, capable and willing to participate.

It should be noted that in one embodiment, access by the agent 144 to the user's information as maintained by the server application 142 may be allowed/disallowed for each user's calendar information. Similarly, the agent 144 may be allowed/disallowed access to user information as maintained by the presence aggregation engine 150.

What will now be described is an example of an embodiment in which both the calendar and scheduling server application 142 and the presence aggregation engine 150 are queried by the agent 144 in connection with establishing or setting up a communication event. It should be noted that an embodiment may include an agent 142 which utilizes only the server application 142 or only the engine 150 in connection with establishing a communication event. An embodiment may also utilize other services, alone or in combination with those described herein, in connection with establishing the communication event by the agent 144.

As an example, A submits an order to the automated agent 144 with multiple requests for the day. The order includes a total of 4 requests and requests 2-4 are to be performed after the event of request 1 has been completed. A first request is for a telephone call with B at anytime during the business day. A second request is for a telephone call with C at anytime during the business day but after the call with B (e.g., first request). A third request is for a telephone call with D at anytime during the business day but after the call with B (e.g., first request). A fourth request is for a video conference with E at anytime during the business day, but after the call with B (e.g., first request). Before processing any requests, the agent 144 may query the engine 150 to obtain device capability information for each registered user to determine if a request has been submitted which cannot be satisfied. For example, A has requested a video conference with E. The agent 144 may determine whether E has any devices registered capable of video conferencing. If not, the agent may not proceed any further with such requests.

The agent may proceed with the first request for a telephone call between A, the requester, and B. The agent may query the server application 142 to examine calendars for A and B for the day. The agent may determine a first time that both A and B are available in accordance with their calendars. In trying to determine a time when both A and B appear to be free for a telephone call, the agent may query the server application 142 for a variety of information about an appointment much like the engine 150. The agent may reserve a portion of time in A and B's calendars if nothing is scheduled at the time selected by the agent. It may also be that one or both of A and B's calendars has an appointment scheduled, but the agent determines that both A and B are still available for a telephone call. For example, A may have no appointment scheduled at a first time. B may have an appointment scheduled at the first time. The appointment information for B may indicate that B has reserved “office time” and that phone calls are accepted at the first time. The agent then waits until the first time and then queries the engine 150 to determine a physical presence for A and B. The agent determines that A has a physical presence of “present” at his office phone and B is similarly “present” at his office phone. The agent contacts B, the non-requester, first to inquire if he is willing to have a telephone call with A. If B accepts, then the agent contacts A to determine if he is willing to have the requested call with A. If so, then the agent sets up the communication links for the phone call between A and B. If B indicates that he is not willing to take the call, or if he is not physically present near a device available to receive phone calls, the agent may perform other processing. The other processing may vary with each embodiment and request. An embodiment may, for example, proceed with processing to determine another time for the call.

In this example, the agent processes the second request after the phone call for first request has occurred due to the specified dependency. The agent may proceed in connection with the second request to establish the second phone call in a manner similar to establishing the first phone call. It should be noted that the communication events for the second, third and fourth requests have no specified order dependency other than on the first request. Accordingly, the agent may proceed with processing the second, third and fourth requests in any order relative to one another. In connection with processing the fourth request, the agent may determine that both A and E are both currently free with no scheduled appointments in accordance with their calendars. The agent determines that, at the current time, E is physically present near her mobile phone without video conferencing availability. Accordingly, the agent may determine another time when E has video conferencing availability. The agent may try to establish the communication event after a predetermined time period has lapsed to determine if A and E are available. E may be in her car and arrives at the office. The agent performs processing and determines that E is physically present near E's computer which has video conferencing availability. The agent proceeds to contact both E and A to establish the video conference.

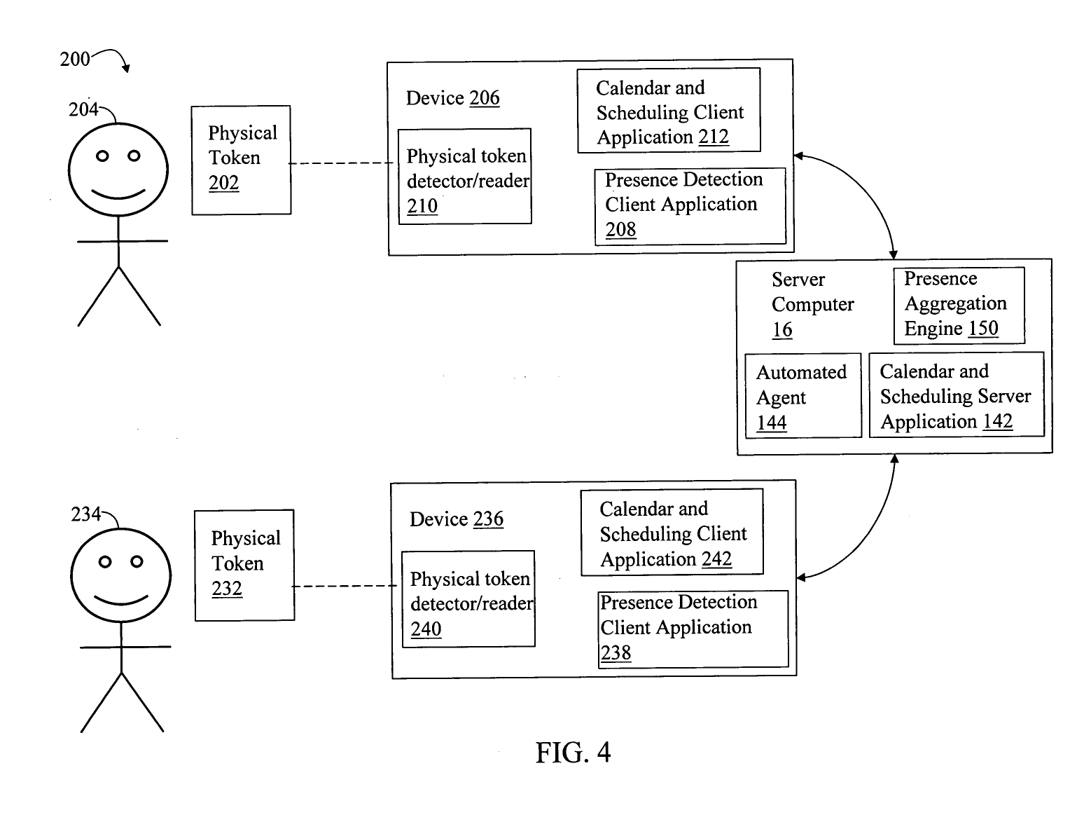

Referring now to FIG. 4, shown is an example 200 illustrating the data flow between components of devices and the server computer in one embodiment. It should be noted that the components of FIG. 4 make reference to similarly named components described elsewhere herein such as in connection with FIGS. 2 and 3. It should be noted that the device 206 represents any device that has connectivity to the server computer 16. Particular examples of a device 206 are a user computer, mobile communication device, office phone and others illustrated herein and known in the art.

In the example 200, a user 204 has a physical token 202. The detector/reader module 210 is used in connection with determining the physical presence or proximity of the physical token 202 to the device 206. If the module 210 determines that the physical token is near the device 206, such as in connection with use of an RFID tag, the module 210 communicates the information regarding the physical token to the presence detection client application 208. The client application 208 may receive also receive a manual physical presence setting and secondary indicator information, for example, from another application 212. The client application 208 may report received information to the presence aggregation engine 150 of the server computer 16. The components of device 236 operate in a manner similar to that as described in connection with device 206.

The engine 150 may obtain other secondary indicator information from the calendar and scheduling server application 142. The information aggregated by the engine 150 may be used in determining a physical presence and available modes of communication for registered users with respect to registered user devices. At any point in time, the automated agent 144 may query the engine 150 determine a physical presence and associated modes of communication for registered users with respect to communication devices registered for each user. The agent 144 may also query the calendar and scheduling application 142 to access calendar and appointment information. Such information may be used by the agent 144, alone or in combination with information from the engine 150, in connection with determining when a party is available for a communication event. When the agent 144 determines at time that both parties are available, the agent 144 establishes the necessary communication links and connects the parties to one another.

What will now be described are flowchart summarizing processing steps that may be performed in an embodiment in connection with the techniques described herein.

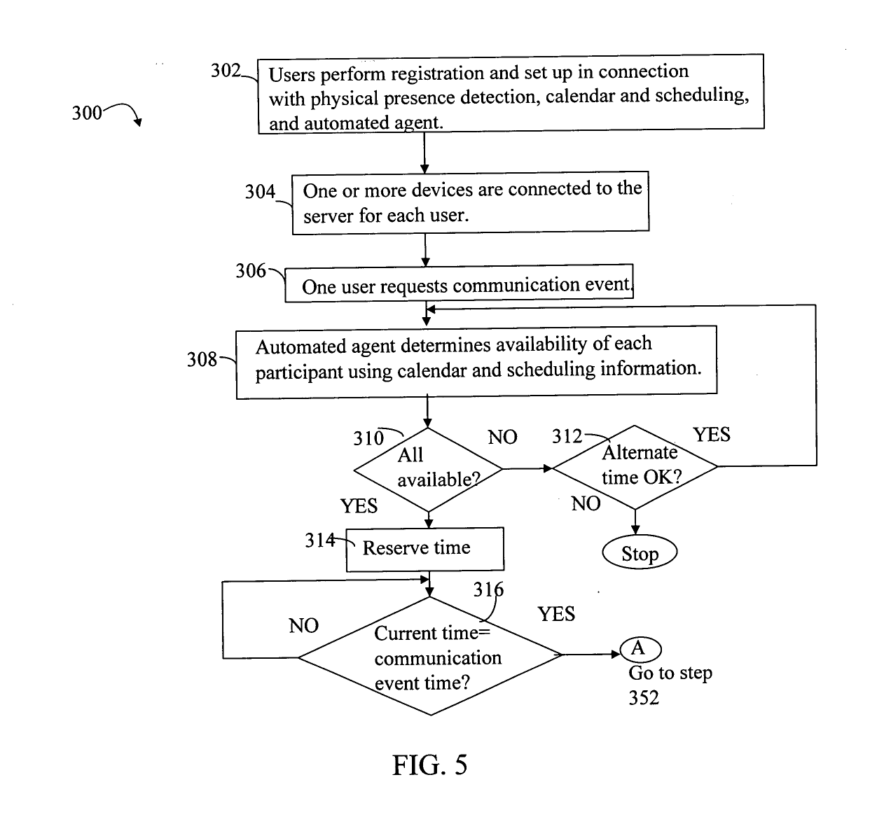

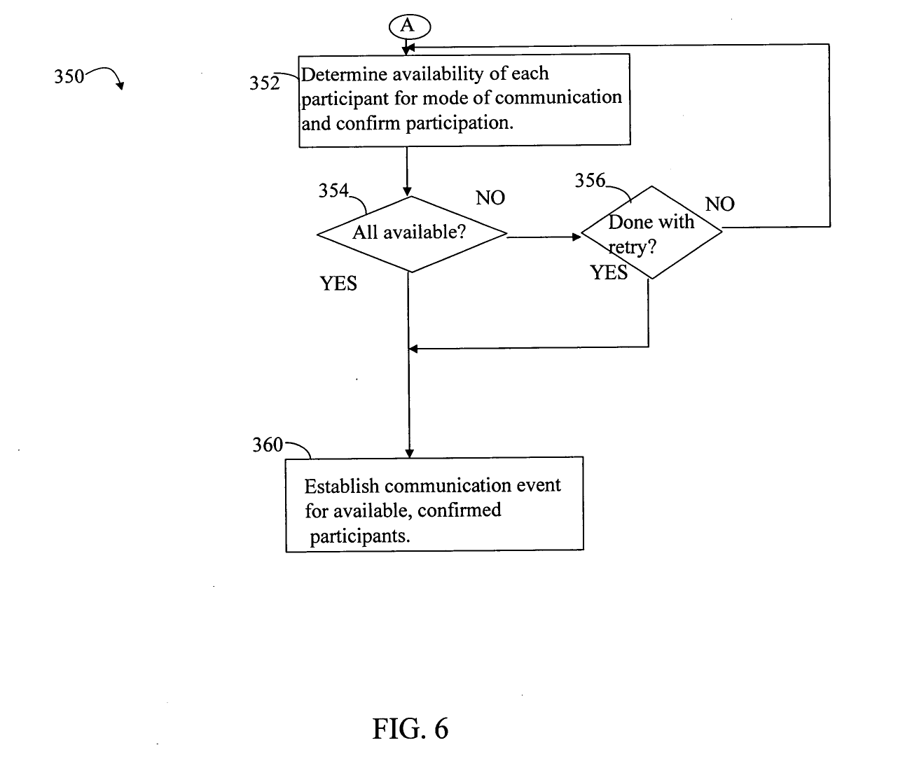

Referring now to FIGS. 5 and 6, shown are flowcharts of processing steps that may be performed by the automated agent in connection with establishing or setting up a communication event between two or more parties. In this example, the agent 144 uses information from the engine 150 to determine physical presence and available modes of communication for users with respect to a device. The agent 144 also uses the appointment information from the server application 142 in making an initial determination of availability.

Steps 302, 304 and 306 are performed at some point prior to the agent 144 executing and processing requests. At step 302, users perform registration and set up in connection with enabling physical presence detection for their registered devices. Setup may also be performed in order to have electronic calendar and scheduling information for each user on the server computer. The proper permissions are set so that the agent 144 is able to obtain information from both the engine 150 and the server application 142. At step 304, one or more of the registered devices for each user are connected to the server. Step 304 may include performing device authentication as described herein in order to establish connectivity to the server and associate the device with a particular registered user having a user identifier. At step 306, a user requests a communication event by submitting, for example, a request to the automated agent using a web browser. At step 308, the automated agent may determine the availability of each participant in the request using calendar and scheduling information. At step 308, the agent accesses the appointment information for each user and determines a time when all parties appear either free (e.g., with no scheduled appointment), or with a scheduled appointment which, upon further examination of information for the appointment entry, indicates that the party is available for the requested communication. Recall that the server application 142 may be queried by the agent 144 for other information about an appointment entry. The agent 144 may obtain information, such as the secondary indicator information described herein, about the entry through querying in a manner similar to engine 150. The agent 144 may examine appointment information for all parties with respect to a current time or a future time in accordance with the request being processed.

At step 310, a determination is made as to whether the agent 144 has determined a time in accordance with the calendar and scheduling information in which all requested parties are free. If not, control proceeds to step 312 where a determination is made as to whether an alternate time has been specified and may be used in connection with scheduling the communication event of the current request. If step 312 evaluates to yes, control proceeds to step 308 to determine availability with respect to the alternate date/time. If step 312 evaluates to no, processing stops. In an embodiment, the request may include explicit alternate date/times set forth by the request initiator. In one embodiment, the agent may report back to the request originator regarding any inability to determine an available time within the request parameters such as when step 312 evaluates to no.

If step 310 evaluates to yes, control proceeds to step 314 where the agent may reserve time in the parties' calendars as appropriate if the parties are free. Recall that a party may have a scheduled appointment but may be available to participate in the requested communication event. In the latter case, the agent may not be able to reserve time in the calendar of a party. Control proceeds to step 316 where the agent waits until the time of the communication event as determined at step 308. It should be noted that if the available time as determined in step 308 is the current time, no waiting occurs at step 316. If the determined available time is for a future time, the agent waits until such time arrives. Control then proceeds to step 352 where the agent determines the current availability of each participant for the mode of communication in accordance with the communication event. Step 352 processing also includes obtaining confirmation from each party regarding willingness to participate. In one embodiment, step 352 processing includes the agent obtaining physical presence information and currently available modes of communication for each party. Step 352 may also include contacting each party to receive confirmation that each party is willing to participate in the communication event. The agent may communicate with each party, for example, using the mode of communication associated with the communication event to obtain confirmation/denial regarding willingness to participate. At step 354, a determination is made as to whether all parties, including the request originator, are available and have confirmed willingness to participate as determined by step 352 processing. If step 354 evaluates to yes, control proceeds to step 360 to establish the communication event by setting up communication links between all parties. It should be noted that in one embodiment, the agent may contact the request originator last after positively completing step 352 processing for all other parties.

If step 354 evaluates to no, control proceeds to step 356 to perform retry processing. In one embodiment, one or more repeated attempts may be made to try and include all requested parties. It may be, for example, that someone is a few minutes late in getting to a location with the device having the communication mode for the requested event. As such, the processing of steps 352 and 354 may be performed for a specified number of times and/or for a predetermined time period. If step 356 evaluates to no indicating that retry processing is not complete, control proceeds to step 352. If step 356 evaluates to yes, control proceeds to step 360 to establish the event for those parties currently available who have confirmed.

It should be noted that the embodiment described in connection with FIGS. 5 and 6 is in accordance with a default policy to try to contact all parties. If all parties are not available and have not confirmed, as determined by step 352, the communication event occurs for all those who are available and have confirmed. As will be appreciated by those skilled in the art, the processing steps of FIGS. 5 and 6 set forth one particular embodiment and variations therefrom may be readily determined. For example, as described herein, a required or minimum set of parties may be specified in the request. As such, step 360 may be performed in such an embodiment only when step 354 evaluates to yes for the required parties.

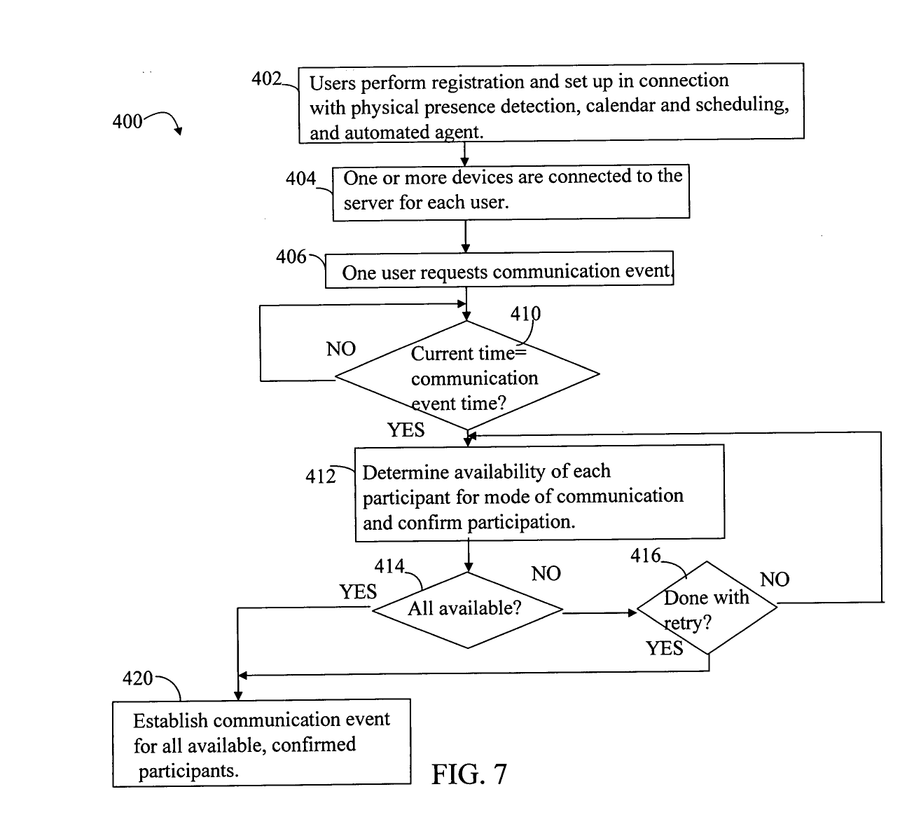

Referring now to FIG. 7, shown is another flowchart of processing steps that may be performed by the automated agent in connection with establishing or setting up a communication event between two or more parties. In this example, the agent 144 uses information from the engine 150 to determine physical presence and available modes of communication for users with respect to a device without making an initial determination in accordance with appointment information from the server application 142. In other words, the agent 150 does not query the server application 142 but rather only queries the engine 150. Steps 402, 404, and 406 are similar, respectively, to steps 302, 304 and 306 of FIG. 5. At step 410, a determination is made as to whether the current time is the time indicated for the communication event. The time for the communication event may include, for example, the next available time, the current time, or a future time. The agent waits at step 410 until the time for the communication event arrives as indicated when step 410 evaluates to yes. When step 410 evaluates to yes, control proceeds to step 412. Steps 412, 414, 416, and 420 include processing similar to that as set forth, respectively, in connection with steps 352, 354, 356, and 360.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of automatically setting up a communication event comprising:
registering a request for a communication event with an automated agent;
determining, by said automated agent, an availability status of each participant in said communication event; and
establishing said communication event.

2. The method of claim 1, wherein said establishing is performed for each available participant.

3. The method of claim 1, wherein said communication event is a conference call.

4. The method of claim 1, wherein said communication event is a video conference.

5. The method of claim 1, wherein said communication event is an instant message.

6. The method of claim 1, wherein said communication event includes at least one mode of communication, wherein said at least one mode of communication includes at least one of: text, voice, and video.

7. The method of claim 1, wherein said availability status of each participant is determined using a calendar and scheduling program for said each participant.

8. The method of claim 1, wherein said availability status of each participant is determined using at least one presence indicator.

9. The method of claim 8, wherein said availability status of each participant is determined using a physical presence indicator.

10. The method of claim 8, wherein said availability status of each participant is determined in accordance with said physical presence indicator of said each participant for a device and in accordance with an available communication mode associated with said device.

11. The method of claim 10, wherein said device is a telephone.

12. The method of claim 10, wherein said device is a mobile communication device.

13. The method of claim 10, wherein said device is a computer system.

14. The method of claim 1, further comprising:
determining, by said automated agent, whether said each participant is available for said communication event in accordance with an application program that tracks appointments for said each participant.

15. The method of claim 14, further comprising:
determining, by said automated agent, a current availability status for each participant when the current time is a time for said communication event.

16. The method of claim 15, wherein said current availability status is determined using a physical presence indicator.

17. The method of claim 1, wherein said establishing is performed by said automated agent.

18. The method of claim 1, wherein said availability status is determined by said automated agent using a physical presence indicator and available modes of communication for each participant, wherein at least one of said available modes of communication for at least one participant is selectively enabled by said at least one participant as a user of a registered device.

19. A computer readable medium comprising executable code for automatically setting up a communication event comprising code that:
registers a request for a communication event with an automated agent;
determines, by said automated agent, an availability status of each participant in said communication event, said availability status being determined in accordance with a physical presence indicator associated with a device for said each participant and available modes of communication for said device; and
establishing said communication event.

20. A method of automatically setting up a communication event comprising:
registering a request for a communication event with an automated agent;
determining, by said automated agent, an availability status of each participant in said communication event, said availability status being determined in accordance with a presence indicator for said each participant; and
establishing said communication event.
